(19) United States
(12) Patent Application Publication
(10) Pub. No.: US 2023/0111645 A1
(43) Pub. Date: Apr. 13, 2023

(54) SYSTEM AND METHOD FOR PAIRING ADOLESCENTS AT SOCIAL EVENTS

(71) Applicant: Garret Sebastian Keyhani, Hillsborough, CA (US)

(72) Inventor: Garret Sebastian Keyhani, Hillsborough, CA (US)

(21) Appl. No.: 17/498,653

(22) Filed: Oct. 11, 2021

(51) Int. Cl. G06Q 50/00; G06Q 50/20; G06Q 10/10

(52) U.S. Cl. CPC G06Q 50/01; G06Q 50/20; G06Q 10/10

(57) ABSTRACT

A system and method allow students to be paired for school events, such as dances, formals, and proms, without having to deal with angst resulting from when to ask and how to ask another student to the event. Teens can be paired with a person with whom they are compatible with or in whom they are interested without even knowing if they were rejected by another person with whom they may have been interested in attending the event.

### FIELD OF THE INVENTION

Aspects of the present invention relate to a practical application of computer technology to facilitate the pairing of adolescents, particularly middle school and high school students, at school social events, while preserving student confidentiality, and preventing students from experiencing direct rejection by peers when seeking dates for the events.

### BACKGROUND OF THE INVENTION

Teenagers encounter many different kinds of social stresses and peer pressures in middle and high school years. The social anxieties students can encounter often are caused by school events, such as dances, formals, and proms. No one wants to go alone or with a friend to these events, and it is never easy for a student to have to ask another student to accompany them to the event, no matter how popular the student may be. The pressure to find a “date” to these types of events has always been overwhelming for adolescents, not just before the event, but even for many weeks or months leading up to the event. While it is normal for students to be fretful, these types of social pressures can be emotionally and mentally debilitating for some. The thought of having to ask another person on a “date,” the possibility of being rejected, and the prospects having to go alone or not going at all can be too much for some teens to handle.

### SUMMARY OF THE INVENTION

Embodiments according to the present invention provide a platform that allows students to be paired for school events, helping students to identify potential dates without having to deal with the angst of when and how to ask other students to the events. Adolescents can be paired with a person with whom they are compatible or in whom they are interested without even knowing if they were rejected by another person with whom they may have been interested in going.

### BRIEF DESCRIPTION OF THE DRAWINGS

Embodiments according to the present invention now will be described in detail with reference to the accompanying drawings, in which:

FIG. 1 is a flowchart of student engagement to select possible dates.

FIG. 2 is a table of possible values that a student might appreciate in a potential date, and of the student's selection of those values.

FIG. 3 illustrates a sample student ranking of other students who are potential dates.

FIG. 4 is a flowchart according to an embodiment.

### DETAILED DESCRIPTION OF EMBODIMENTS

Embodiments of the present invention provide a platform that allows students to be paired for school events, such as dances, formals, and proms, without having to deal with angst resulting from when to ask and how to ask another student to the event. With a platform according to embodiments of the present invention, teens can be paired with a person with whom they are compatible with or in whom they are interested without even knowing if they were rejected by another person with whom they may have been interested in attending the event.

In an embodiment, a website is provided on which a school can register. Once the school registers on this website, the school can provide access to its students through the school's webpage. For security purposes, the school can provide an identification number for a student to log in. In an embodiment, the school can provide a single log in identification code (IDC) for all students, in which case the student can create his or her profile with a confidential password. Alternatively, the school can provide a customized IDC to each of its students. While the school can monitor the site, the students will not have any kind of means to communicate with each other through the website. No student will be able to direct message another student via the platform. Moreover, the information provided on the website is maintained as confidential. Other students will not have access to the information of the other students other than the list of names from which each student can select.

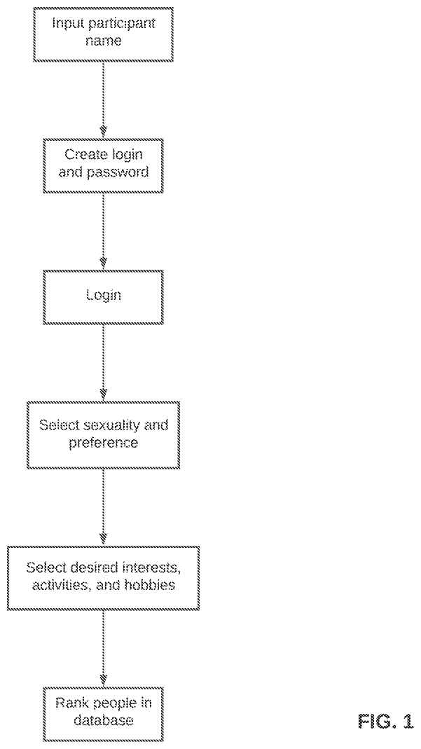

Referring to FIG. 1, at 110 each student enters their name. Depending on whether the school has provided its students with their individual login and password, at 120 each participating student may create their own login and password. In an embodiment, at 130 the student may log in using their school IDC and password. At 140, the student may select their sexuality and preference. In an embodiment, the student name may be saved in a database.

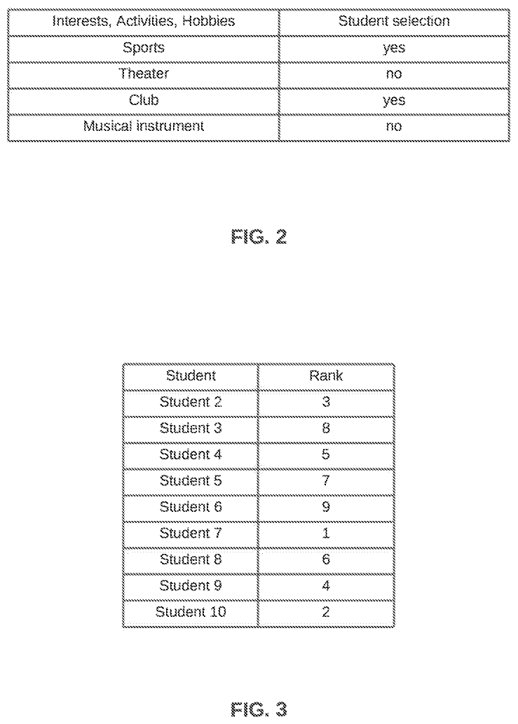

At 150, each participating student may select from a preset list of values, which can include interests, activities, and hobbies. The student's selection will be kept confidential, and will not be shared with other students or with the school. In an embodiment, as part of 150, each participating student may select (with yes/no, or with a checked box) their own list of values from the preset list. In an embodiment, the list is not extensive, to make it easier for students to create a list more easily. Ordinarily skilled artisans will understand the types of interests, activities, and hobbies that students at a particular grade level or at a particular school may have. As time goes on, relevant lists of interests, activities, and hobbies may change. FIG. 2 shows examples of such interests, activities, and hobbies, and of student selections.

At 160, the student may access the database to rank their choices of date in order of preference. Depending on the embodiment, a student can limit the ranking to one person, or can rank as many other students as they wish. FIG. 3 shows an example of rankings.

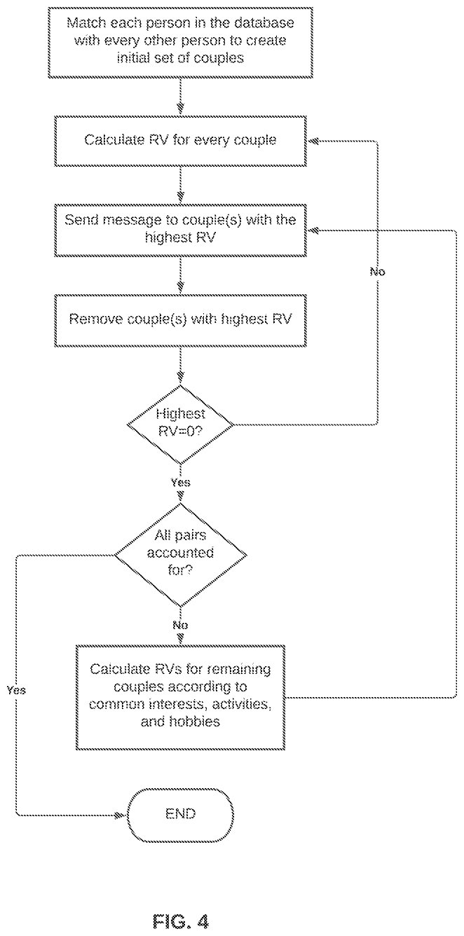

FIG. 4 illustrates actions after the student selects interests, activities, and hobbies, and ranks preferred matches. At 410, each person participating in the pairing system is matched with every other participant. A plurality of possible combinations/couples will result. At 420, a “relationship value” (RV) is graded or calculated for each pair of students regardless of whether one has ranked the other.

Calculating the RV is as follows:

(1) Let X=total number of participating students in the database, multiplied by the constant 2.

(2) For each pair of students, subtract the sum of both person's ranking from X to calculate each pair's RV.

(3) If one student has not ranked another student, the RV=0.

### Example 1

X=100 (i.e., 50 students participating); Student A has ranked Student B as rank 1 and Student B has ranked Student A as rank 1. This creates a RV for this couple is 100−(1+1)=98.

### Example 2

X=100 (i.e., 50 students participating); Student A has ranked Student B as rank 3; Student B has ranked Student A as rank 1; Student B has ranked Student C as rank 5; and Student C has ranked Student A as unranked; and Student C has ranked Student B as 2.

Couple A-B has RV of 96 (100−(3+1))

Couple A-C has RV of 0

Couple B-C has RV of 93 (100−(5+2))

After all the calculations, at 430, a message is sent to each couple having the highest RV. Each person in the couple may receive a message saying, for example, “Congratulations!!!! You have been matched with ______.” After this message, at 440 the couple with the highest RV is removed from the group of students within the algorithm. At 450, if there still is an RV that is greater than zero, flow returns to 420 to perform RV calculations for all of the remaining pairs. Because a couple has been removed, some of the RVs will no longer be relevant. In an embodiment, calculations involving either student in the removed couple may be removed, and the remaining calculations retained. In that event, flow may return to 430 to tell the next couple they have been paired.

At 460, if there are no non-zero RVs, a determination is made whether all couples have been accounted for. If so, at 480 the flow ends. If all couples have not been accounted for, then RVs are re-calculated for remaining couples according to a number of common interests, activities, and hobbies, and flow returns to 430 to tell the next couple they have been paired.

In an embodiment, in case of a tie for the highest RV, all pairs having that RV may be removed, except for pairs that involve the same person.

### Example 3

X=100; Student A has ranked student B as rank 1; Student B has ranked Student A has rank 3; Student A has ranked student C as rank 2; Student C has ranked student A has rank 2.

Couple A-B has RA value of 96

Couple A-C has RA value of 96

Couple A-B and A-C are tied for the highest RA value. However, since they have a common person, that is, student A, the algorithm defers to student ranking of interests, activities, and hobbies. The RV will then increase by 1 value point for each such common interest, activity, or hobby. Consequently, if A and C have 1 value point and B and C do not have any value points, couple A-C wins the tie-breaker, and couple A-C is matched over couple A-B.

In an embodiment, if there is still a tie, for example each couple having the same number of value points, then the deciding factor may be a common person among the pairs. Whoever the common person ranked higher will be the person selected for that couple.

Next, although unlikely, there may be a pool of leftover students, none of whom has an RV above 0 with any other remaining student. In this case, the process will be repeated with a new construct dictating relationship values. Rather than utilizing student rankings, RVs may be decided by the number amount of common interests, activities, and hobbies that a pair has.

### Example 4

Student A and student B have 4 common interests and values. Their RV is 4.

The other and final distinction between this process and the last is how to determine the outcome of a tie with a common person. When this happens, in an embodiment the algorithm resorts to alphabetical order (using the last names of the uncommon people within the pairs).

Ordinarily skilled artisans will appreciate that the above-described methods may be performed on a number of different computer systems, with suitably programmed processors running programs stored in any of various types of non-transitory storage media, to execute necessary instructions to perform appropriate parts of the above-described methods.

While the invention has been described in detail with reference to embodiments, ordinarily skilled artisans will appreciate that various modifications within the scope and spirit of the invention are possible. Accordingly, the invention should be considered as limited only by the scope of the following claims.

1. A method comprising:
a) receiving, at a platform, an identifier corresponding to a name of a person and inputting the name of the person into a database;
b) creating a login and password for the person;
c) processing, by the platform, a logging in of the person;
d) providing options of sexuality and preference to the person and receiving a selection of sexuality and preference from the person;
e) providing options of desired interests, activities, and hobbies to the person and receiving a selection of desired interests, activities, and hobbies from the person for input into a database record for said person;
f) providing access to the database to the person, the database containing records of other people, and accepting the input by the person of a respective ranking of a corresponding one of the other people, into the database record for the corresponding one of the other people, and providing further access to the database for ranking of up to a predetermined limit;
g) matching, by the platform, each person having a database record with every other person having a database record to create a plurality of couples;
h) calculating, by the platform, a relationship value for each of said plurality of couples;
i) notifying, by the platform, a couple with the highest relationship value that the couple has been paired;
j) removing, by the platform, the couple with the highest relationship value from the database; and
k) repeating, by the platform, h)-j) until there are no non-zero relationship values;
l) responsive to a determination that there are no non-zero relationship values, calculating, by the platform, further relationship values for remaining couples according to common interests, activities, and hobbies.

2-5. (canceled)

6. The method of claim 1, further comprising:
repeating i)-l) until there are no more couples to be paired.

7. A system comprising:
a processor; and
a non-transitory storing a program which, when executed by a processor, performs a method comprising:
a) receiving, at the apparatus, an identifier corresponding to a name of a person and inputting the name of the person into a database;
b) creating a login and password for the person;
c) processing, by the platform, a logging in of the person;
d) providing options of sexuality and preference to the person and receiving a selection of sexuality and preference from the person;
e) providing options of desired interests, activities, and hobbies to the person and receiving a selection of desired interests, activities, and hobbies from the person for input into a database record for said person;
f) providing access to the database to the person, the database containing records of other people, and accepting the input by the person of a respective ranking of a corresponding one of the other people, into the database record for the corresponding one of the other people, and providing further access to the database for ranking of up to a predetermined limit;
g) matching each person having a database record with every other person having a database record to create a plurality of couples;
h) calculating a relationship value for each of said plurality of couples; and
i) notifying a couple with the highest relationship value that the couple has been paired;
j) removing the couple with the highest relationship value from the database.
k) repeating h)-j) until there are no non-zero relationship values.
l) responsive to a determination that there are no non-zero relationship values, calculating further relationship values for remaining couples according to common interests, activities, and hobbies.

8-11. (canceled)

12. The system of claim 11, wherein the method further comprises:
repeating i)-l) until there are no more couples to be paired.

13. The method of claim 1, wherein the predetermined limit is one other person.

14. The method of claim 1, wherein the predetermined limit is all the other person.

15. The system of claim 7, wherein the predetermined limit is one other person.

16. The system of claim 7, wherein the predetermined limit is all the other person.

17. The method of claim 1, wherein the predetermined limit is one other person.
